(19) United States
(12) Patent Application Publication
(10) Pub. No.: US 2026/0195826 A1
(43) Pub. Date: Jul. 9, 2026

(54) OPTIMIZING MANUFACTURING PROCESSES

(71) Applicant: INTERNATIONAL BUSINESS MACHINES CORPORATION, ARMONK, NY (US)

(72) Inventors: Vivek Warrier, Bengaluru (IN); Mukundan Sundararajan, Bangalore (IN); Anita Duggal, Delhi (IN)

(21) Appl. No.: 19/009,848

(22) Filed: Jan. 3, 2025

(51) Int. Cl. G06Q 50/04; G06F 40/279; G06Q 10/0637; G06Q 30/0282

(52) U.S. Cl. CPC G06Q 50/04; G06F 40/279; G06Q 10/06375; G06Q 30/0282

(57) ABSTRACT

A method for manufacturing in a manufacturing environment includes categorizing one or more features of a product based on a manufacturing process that includes a number of manufacturing operations, with each operation corresponding to a specific product feature. User input related to product enhancements is collected through various channels and analyzed using natural language processing (NLP) to identify desired product enhancements. The identified enhancements are prioritized through a trade-off analysis that evaluates resource utilization, production time, and operational constraints. The prioritized enhancements are then mapped to corresponding manufacturing operations to identify necessary adjustments in the manufacturing process. The manufacturing process is dynamically reconfigured to implement the identified adjustments or to generate new product variants.

### BACKGROUND

### Technical Field

The present disclosure generally relates to optimizing manufacturing processes in manufacturing environments.

### Description of the Related Art

Conventional manufacturing systems primarily rely on pre-defined workflows and fixed production setups. These systems include, for example, batch manufacturing in which products are manufactured in batches, and continuous manufacturing in which products are manufactured continuously.

Recently, modern manufacturing practices have become widely adapted, including the use of automation and robotics. For example, some manufacturing systems may include control systems configured to control the performance of different parts of a manufacturing system to achieve a desired manufacturing outcome.

### BRIEF SUMMARY

According to an illustrative embodiment, a method for manufacturing in a manufacturing environment is disclosed. The method includes categorizing one or more features of a product based on a manufacturing process that includes a plurality of manufacturing operations, where each manufacturing operation is associated with a corresponding feature of the product. The method includes collecting user input related to enhancements of the product and analyzing the collected user input using natural language processing to identify relevant product enhancements. Further, the method includes prioritizing the identified product enhancements by performing a trade-off analysis based on resource utilization, production time, and operational constraints, and mapping the prioritized product enhancements to the corresponding manufacturing operations to identify adjustments in the manufacturing process. The manufacturing process is then dynamically reconfigured to implement the identified adjustments or to generate new product variants based on the prioritized product enhancements.

In one embodiment, the method further includes producing and refining prototypes of the product by generating prototypes incorporating the prioritized product enhancements, “beta” testing the prototypes with target users, or iteratively refining the prototypes based on feedback obtained during the beta testing.

In one embodiment, the tested prototypes are analyzed using statistical tools to determine performance metrics of the prototypes and identify additional areas of improvement.

In one embodiment, the method further comprises generating a simulation model to predict an impact of the prioritized product enhancements on production efficiency and overall costs before implementing the adjustments. According to an embodiment of the present disclosure, a computing device includes a processor and a memory with computer program instructions that, when executed, enable the device to categorize one or more features of a product based on a manufacturing process including a plurality of manufacturing operations, where each manufacturing operation is associated with a corresponding feature of the product. The program instructions further cause the computing device to collect user input related to enhancements of the product and analyze the collected user input using natural language processing to identify relevant product enhancements. The program instructions further cause the computing device to prioritize the identified product enhancements by performing a trade-off analysis based on resource utilization, production time, and operational constraints, and map the prioritized product enhancements to the corresponding manufacturing operations to identify adjustments in the manufacturing process. Furthermore, the program instructions further cause the computing device to dynamically reconfigure the manufacturing process to implement the identified adjustments or generate new product variants based on the prioritized product enhancements.

According to an embodiment, a computer program product includes a computer-readable storage device and program instructions executable by a processor, comprising program instructions to categorize one or more features of a product based on a manufacturing process comprising a plurality of manufacturing operations, with each manufacturing operation being associated with a corresponding feature of the product. The program instructions further include program instructions to cause the computing device to collect user input related to enhancements of the product and to analyze the collected user input using natural language processing to identify relevant product enhancements. The program instructions further include program instructions to cause the computing device to prioritize the identified product enhancements by performing a trade-off analysis based on resource utilization, production time, and operational constraints, and map the prioritized product enhancements to the corresponding manufacturing operations to identify adjustments in the manufacturing process. Furthermore, the program instructions further include program instructions to cause the computing device to dynamically reconfigure the manufacturing process to implement the identified adjustments or generate new product variants based on the prioritized product enhancements.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 depicts a block diagram of a network of manufacturing processing systems configured for dynamic optimization in accordance with an illustrative embodiment.

FIG. 2 depicts a block diagram of a computing environment in accordance with an illustrative embodiment.

FIG. 3 depicts a block diagram of a manufacturing environment showcasing the integration of feedback-driven enhancements and dynamic reconfiguration mechanisms in accordance with an illustrative embodiment.

FIG. 4 depicts a flowchart outlining the process for managing product enhancements, prototype development, and manufacturing in a feedback-driven manufacturing environment in accordance with an illustrative embodiment.

FIG. 5 depicts a flowchart of a method for dynamically optimizing manufacturing processes in a manufacturing environment in accordance with an illustrative embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The present disclosure generally relates to enhancing manufacturing processes based on data-driven insights such as feedback from customers, and dynamically reconfiguring manufacturing systems based on the data-driven insights. Manufacturing environments may often be subject to shifts in consumer demands, resource availability, and operational constraints, which may benefit from adaptable methods to ensure competitiveness and efficiency.

Some approaches to manufacturing may rely on predefined processes and static configurations that can be resource-intensive and slow to adapt to changing user demands. Though these methods may be effective in stable conditions, they may be deficient in addressing the dynamic changes desired in modern manufacturing environments for the purpose of optimizing production, including the implementation of prototypes for testing.

The disclosed methods and systems utilize data analysis techniques, including as natural language processing and predictive analytics, to extract meaningful insights from disparate feedback channels. The disclosed methods and systems further map the insights to manufacturing and enable a structured and automated approach to implementing product enhancements and adapting workflows.

The illustrative embodiments categorize product features and link the features to specific manufacturing steps, thus, streamlining the identification and prioritization of identified product enhancements or features. This categorization allows evaluating how feature changes can improve (e.g., optimize) use of manufacturing components, while maintaining operational flexibility through dynamically reconfiguring manufacturing setups.

Certain operations are described as occurring at a certain component or location in an embodiment. Such locality of operations is not intended to be limiting on the illustrative embodiments. Any operation described herein as occurring at or performed by a particular component, can be implemented in such a manner that one component-specific function causes an operation to occur or be performed at another component, e.g., at a local or remote engine respectively. In one aspect, the method described herein, is implemented to execute on a particularly configured computing device or data processing system and provides substantial advancement of the functionality of that computing device or data processing system by enabling the dynamic reconfiguration of manufacturing environments to test and implement prototypes while incorporating user input and manufacturing constraints. Embodiments thus have the capacity to improve the manufacturing environment, including extreme manufacturing and automation by managing the sourcing and use of pertinent manufacturing information in cohesive feedback cycle.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures, therefore, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

### Data Processing Environment

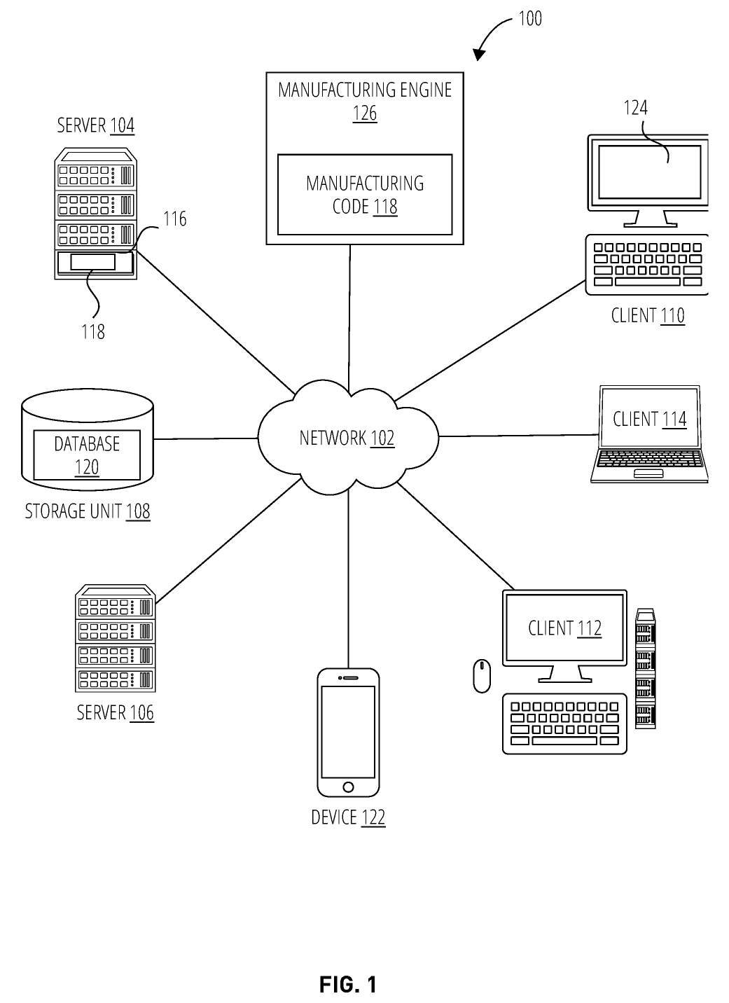

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as clients (client 110, client 112, client 114), Manufacturing Engine 126, and device 122, may include data and may have software applications or software tools executing thereon. Server 104 and server 106 may include one or more GPUs (graphics processing units) for statistical analysis or machine learning.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system, which are all within the scope of the illustrative embodiments.

Data processing systems (manufacturing engine 126, server 104, server 106, client 110, client 112, client 114, and device 122) also represent example nodes in a cluster, partitions, and other configurations suitable for implementing an embodiment.

Server 104, server 106, storage unit 108, client 110, client 112, client 114, device 122, manufacturing engine 126 may couple to network 102 using wired connections, wireless communication protocols, or other suitable data connectivity. Client 110, client 112 and client 114 may be, for example, personal computers or network computers.

In the depicted example, the servers may provide data, such as boot files, operating system images, and applications to client 110, client 112, and client 114. Client 110, client 112 and client 114 may be clients to servers in this example. Client 110, client 112 and client 114 or some combination thereof, may include their own data, boot files, operating system images, and applications. Data processing environment 100 may include additional servers, clients, and other devices that are not shown. Server 104 may include a server application 116 that may be configured to implement one or more of the functions described herein in accordance with one or more embodiments. Server application 116, client application 124 and/or manufacturing engine 126 may include manufacturing engine (e.g., code) 118, configured for dynamically reconfiguring manufacturing workflows based on user input and market trends.

Device 122 is an example of a device described herein. For example, device 122 can take the form of a smartphone, a tablet computer, a laptop computer, client 110 in a stationary or a portable form, or any other suitable device. Any software application described as executing in another data processing system in FIG. 1 can be configured to execute in device 122 in a similar manner. Any data or information stored or produced in another data processing system in FIG. 1 can be configured to be stored or produced in device 122 in a similar manner. Database 120 of storage unit 108 may store one or more feedback or market trend data for computations herein.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with reduced (e.g., minimal) management effort or interaction with a provider of the service.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 includes an example of an environment for the execution of at least some of the computer code involved in performing the inventive methods, such as manufacturing code 118. In addition to manufacturing code 118, computing environment 200 includes, for example, Computer 202, wide area network 228 (WAN), end user device 230 (EUD), remote server 232, public cloud 240, and private cloud 236. In this embodiment, Computer 202 includes processor set 204 (including processing circuitry 206 and cache 208), communication fabric 210, volatile memory 212, persistent storage 214 (including operating system 216 and manufacturing code 118, as identified above), peripheral device set 218 (including user interface (UI) device set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

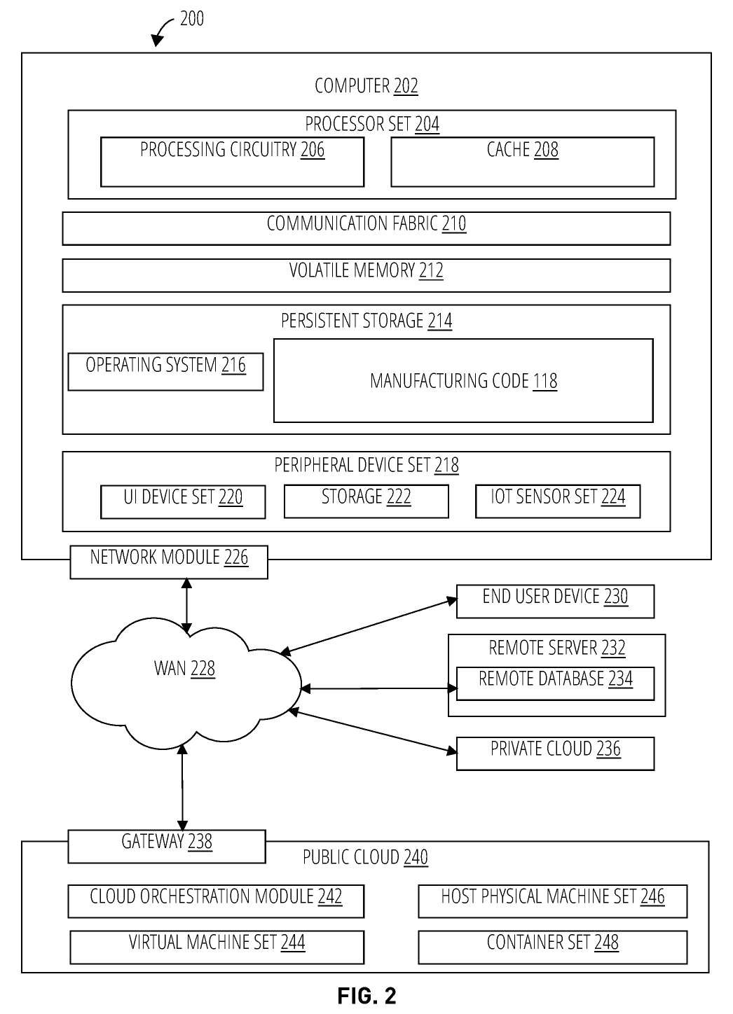

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically Computer 202, to keep the presentation as simple as possible. Computer 202 may be located in a cloud, even though it is not shown in a cloud in FIG. 2. On the other hand, Computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip.” In some computing environments, processor set 204 may be designed for working with qubits and performing quantum computing.

Computer readable program instructions are typically loaded onto Computer 202 to cause a series of operational steps to be performed by processor set 204 of Computer 202 and thereby effect a computer- implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in manufacturing code 118 in persistent storage 214.

Communication fabric 210 is the signal conduction path that allows the various components of Computer 202 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In Computer 202, the volatile memory 212 is located in a single package and is internal to Computer 202, but, alternatively or additionally, the volatile memory may be distributed over multiple packages and/or located externally with respect to Computer 202.

Persistent storage 214 is any form of non-volatile storage for computers that is now known or to be developed in the future. The non-volatility of this storage means that the stored data is maintained regardless of whether power is being supplied to Computer 202 and/or directly to persistent storage 214. Persistent storage 214may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in manufacturing code 118 typically includes at least some of the computer code involved in performing the inventive methods.

Peripheral device set 218 includes the set of peripheral devices of Computer 202. Data communication connections between the peripheral devices and the other components of Computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game controllers, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where Computer 202 is required to have a large amount of storage (for example, where Computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications. For example, one sensor may be a thermometer, and another sensor may be a motion detector.

Network module 226 is the collection of computer software, hardware, and firmware that allows Computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 230 is any computer system that is used and controlled by an end user (for example, a customer of an enterprise that operates Computer 202) and may take any of the forms discussed above in connection with Computer 202. EUD 230 typically receives helpful and useful data from the operations of Computer 202. For example, in a hypothetical case where Computer 202 is designed to provide a recommendation to an end user, this recommendation would typically be communicated from network module 226 of Computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to Computer 202. Remote server 232 may be controlled and used by the same entity that operates Computer 202. Remote server 232 represents the machine(s) that collect and store helpful and useful data for use by other computers, such as Computer 202. For example, in a hypothetical case where Computer 202 is designed and programmed to provide a recommendation based on historical data, then this historical data may be provided to Computer 202 from remote database 234 of remote server 232.

Public cloud 240 is any computer system available for use by multiple entities that provides on- demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

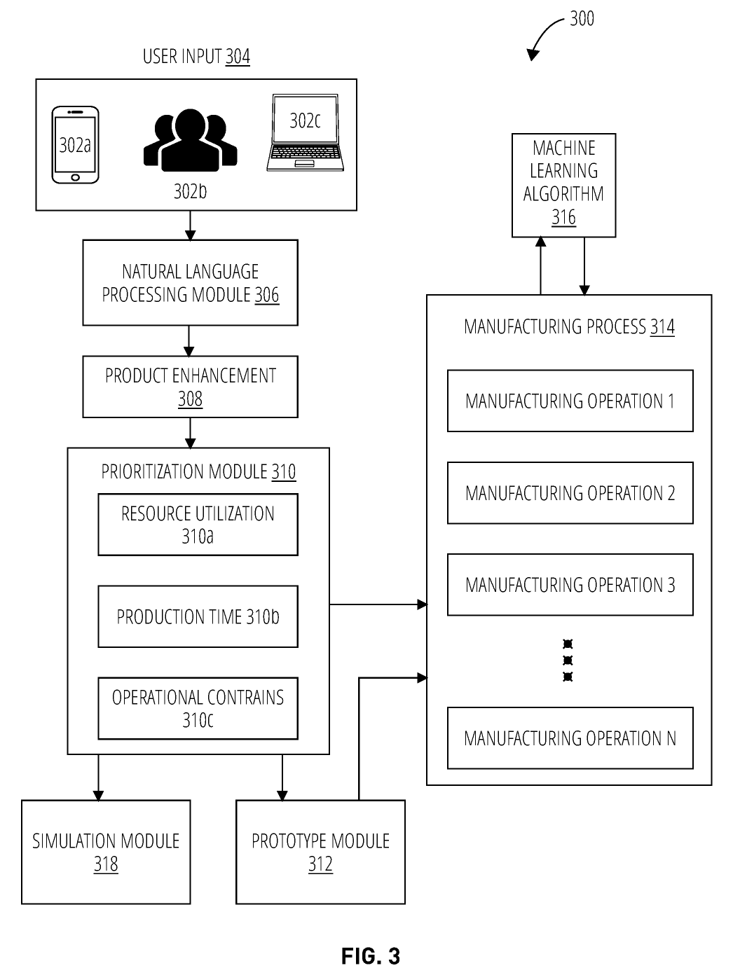

Reference now is made to FIG. 3, which illustrates a block diagram of a manufacturing environment 300 showing the integration of feedback-driven enhancements and dynamic reconfiguration mechanisms in accordance with an illustrative embodiment. The manufacturing environment 300 may be an example of the data processing environment 100 and may generally depict how manufacturing systems leverage interconnected components and real-time feedback to dynamically adjust their operations. This environment 300 exemplifies the principles of Industry 4.0, where advanced technologies such as natural language processing (NLP), machine learning, and feedback-driven decision-making converge to optimize production processes and product development.

At its core, the manufacturing environment 300 highlights a systematic approach to gathering, analyzing, and utilizing user input to refine and enhance manufacturing operations. The framework begins with collecting user feedback from various sources and channels, processing this input to identify meaningful insights, and then dynamically adapting manufacturing processes based on the derived enhancements. This interconnected flow enables the environment to not only respond to user demands but also to anticipate trends and changing user specifications, ensuring that the products meet evolving market expectations.

The manufacturing environment 300 comprises one or more input sources, including, for example, a social media platform 302a, crowdsourcing 302b, and feedback channels 302c, which collectively facilitate the collection of user input 304. For example, in an embodiment in which the product being manufactured is a seat belt for an automobile, user feedback may include suggestions such as enhanced increased durability, comfort, or adjustable mechanisms based on varying body types.

The user input 304 fetched from the social media platform 302a, crowdsourcing 302b, and feedback channels 302c can be obtained through various methods depending on, for example, the stage in the product’s lifecycle and user interaction mechanisms. Social media platforms 302a, such as microblogging websites, video-sharing platforms, or forums, provide an extensive base for gathering user input. For example, in an embodiment directed to a newly launched seat belt product, user opinions may be obtained through comments on promotional posts, hashtags, and social media mentions, or otherwise other user input. For instance, users may discuss the product’s comfort, adjustability, or compatibility with specific car models in public forums or private groups. These conversations may be analyzed using sentiment analysis and keyword extraction techniques through the use of the NLP (natural language processing) module 306 to derive actionable insights. Of course, examples described herein are not meant to be limiting as other products such as electronic devices, mechanical devices, and semiconductors may be manufactured by virtue of the methods and systems described herein. In another embodiment, upon launching a product for testing, focused campaigns may be conducted to solicit user feedback. For instance, beta testers may be prompted to fill out surveys. Further, crowdsourcing 302b may be employed through organizing online discussions or polls to generate information about products such as unknown defects, new features and user preferences. Feedback channels 302c may provide additional pathways for collecting any other useful user input. In embodiments, the user input can be filtered based on predefined criteria comprising one or more of product relevance, user demographics, and geographic location. The collected user input 304 is provided to the NLP module 306, which converts the user input into features or product enhancements by discerning user sentiment, identify recurring themes or requests, and categorize suggestions into specific areas such as safety improvements, comfort enhancements, material upgrades, or functional changes. For example, in the embodiment of the seat belt, the product being the seat belt of an automobile, the NLP module 306 may extract feedback indicating that a significant portion of users express a preference for a more durable material that resists fraying. Furthermore, the NLP module 306 may also recognize other patterns such as a demand for adjustable seat belts or user concerns about the ease of use of the seat belts for different body types, allowing the system to classify these needs under broader categories like safety or user comfort. By processing and classifying user input in this way, the NLP module 306 may enable the manufacturing environment 300 to gain a more accurate understanding of the market’s expectations, which may inform further steps in the manufacturing process. Further, the product enhancements 308 are subsequently prioritized or ranked using the prioritization module 310. The prioritization module may utilize natural language processing or may be a trained machine learning model that is trained to propose the ranking or selection of input product enhancements 308 based on one or more constraints. The prioritization process may consider factors such as resource utilization 310a, production time 310b, and operational constraints 310c. For instance, in the case of the seat belt, resource utilization may include assessing the availability of high-durability materials, while production time may evaluate whether the changes align with implementation capacity of the assembly line of the manufacturing environment 300.More specifically, user feedback such as a desire for a more durable, fray-resistant seat belt material may trigger the assessment of suitable materials. Resource utilization constraints may include evaluating the availability of raw materials and the cost-effectiveness of integrating the new material into the existing production flow, and production time constraints may be evaluated to determine how quickly the new process can be integrated into the existing production schedule. Similarly, operational constraints such as machine compatibility, workforce training, and existing quality control measure may be evaluated to ensure that any changes can be executed within the current manufacturing setup without disrupting other ongoing production lines.

In another embodiment, if the product is a newly launched consumer electronic device, the feedback may be geared towards performance enhancements or ergonomic improvements. For example, user input may suggest improvements in battery life or screen durability. In this case, the prioritization module 310 may focus more on the feasibility of sourcing higher-capacity batteries or improving manufacturing processes for screen strength.

Ultimately, by combining user feedback, production capacity assessments, and resource evaluations, the manufacturing environment 300 may be adapted to continuously identify and select product enhancements for implementation and testing while ensuring current setup of large-scale manufacturing is not disturbed until necessary. The approach may thus allow manufacturers to dynamically adjust manufacturing processes based on market demands while reducing (e.g., minimizing) potential risks.

In other implementations, the prioritization module 310 may be functionally combined with or set up as a module configured to carry out feature root traceability to map manufacturing task/step changes needed in the manufacture of the product enhancements 308. For example, trade-off analysis may be carried out to determine if an identified product enhancement 308 can result in material optimization / savings. In some embodiments, the designs or manufacturing steps that reduce (e.g., minimize) the amount of material discarded during manufacturing and have alternate applications within the product components will have a higher ranking and value.

Upon deciding which one or more prioritized product enhancements are to be implemented or considered, the one or more prioritized product enhancements may be provided to a prototype module 312 configured for iterative testing. Alternatively, the one or more prioritized product enhancements may be provided directly to a manufacturing process 314 after prototyping wherein manufacturing processes may be performed outside of a prototyping operation. The manufacturing process 314 can includes multiple operations, such as cutting, stitching, and quality control checks. For instance, the introduction of a new material for seat belts may require adjustments to the cutting tools or sewing mechanisms.

Once the prioritized enhancements are mapped to the prototypes 312, an iterative testing process may be performed wherein practical implications of the proposed enhancements are evaluated under real-world conditions. In one embodiment, for instance, a prototype incorporating a new material may be produced. The prototype may undergo rigorous testing, including stress testing, durability assessments, crash simulation tests, and other to ensure that the prototype meets safety and performance standards. The results from the prototyping may provide feedback on the effectiveness of the enhancements and allow for further refinement in an iterative nature until a final product ready for use is produced. In an illustrative embodiment where a product enhancement requires the addition of a new component, such as a more efficient motor for a home appliance, the mapping of enhancements to the manufacturing process 314 may involve recalibrating assembly lines and machinery. For instance, introducing a new motor design might require changes in assembly line configurations to ensure that the components are properly integrated during assembly. The manufacturing environment 300 may thus be dynamically reconfigured via, for example, the manufacturing engine 126, to enable the new component to be properly installed while maintaining production efficiency. According to an illustrative embodiment, a machine learning algorithm 316 may be employed to optimize the manufacturing operations dynamically. The algorithm may be configured to evaluate data such as past production data, current operational efficiency, or otherwise manufacturing data to propose configurations that can reduce (e.g., minimize) manufacturing time (downtime) and material waste (wastage). For example, if a seat belt material requires additional stitching steps, the algorithm may rearrange the operations to ensure seamless integration without disrupting other manufacturing processes. In an exemplary embodiment, the machine learning algorithm 316 is configured to learn and adapt based on real-time production data. The algorithm analyzes past performance metrics, such as machine throughput, defect rates, and operational bottlenecks, to identify patterns that may be beneficial to manufacturing strategies.

In another embodiment, the machine learning algorithm 316 can be integrated with a simulation module 318 to create a real-time digital twin of the manufacturing environment 300. This digital twin mirrors the actual production process and is used to simulate potential modifications before being implemented on assembly lines. In some cases, the algorithm may organize resource allocation across multiple production lines. For example, in a manufacturing facility that produces a wide range of automotive components, the machine learning algorithm 316 can analyze production schedules, material availability, and labor resources to determine the most efficient allocation of resources across the different assembly lines. If one line is running behind schedule due to a machine malfunction or material delay, the algorithm may suggest redistributing work to other lines to ensure that overall production targets are met. This helps maintain flexibility in the production system and reduces (e.g., minimizes) the impact of unforeseen disruptions.

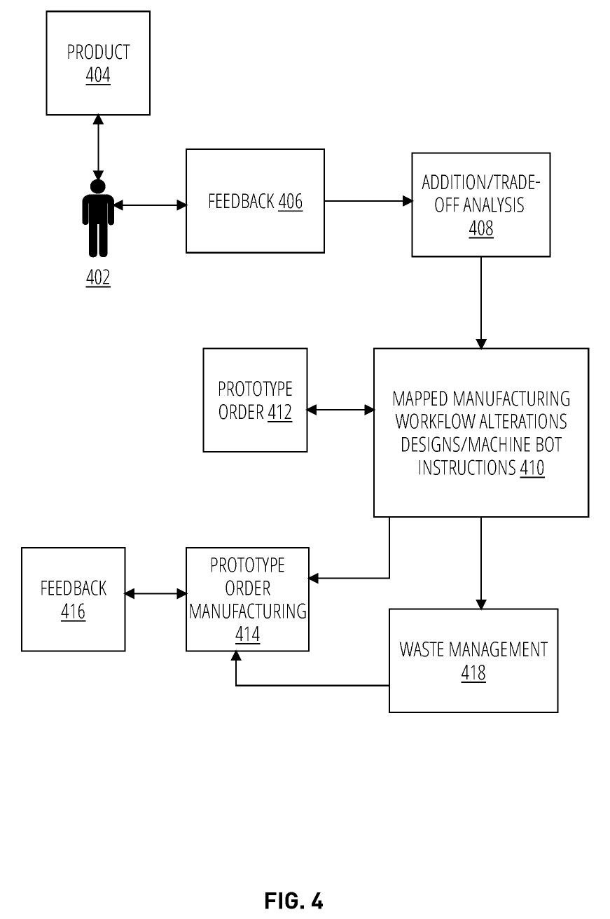

Turning now to FIG. 4, the figure depicts an example flowchart outlining a process for managing product enhancements, prototype development, and manufacturing in a feedback-driven manufacturing environment. The manufacturing environment may use feedback 406, addition/trade-off analysis 408, and iterative prototype testing to refine product designs and manufacturing processes.

The process begins by categorizing the features of a product 404 according to the manufacturing tasks required at each step. The manufacturing process is broken down into discrete functionalities and tasks, each corresponding to a recognizable element of the product 404. These tasks may include producing visible components of the product 404, coding specific functional blocks, or assembling sub-components, etc. The granular breakdown may ensure that the manufacturing process to be clearly defined and optimized for each feature and task involved in the product’s creation.

Once the product features are categorized based on likely manufacturing steps, feedback 406 from a variety of sources, such as from crowdsourcing platforms and social media, is collected. Users 402 provide insights on product enhancements, variants, and potential prototype requests that may be desired for particular components, or a feature being assessed. The feedback 406 is analyzed using natural language processing (NLP) and other data analysis tools to assess the level of market interest and demand for each feature. The system categorizes the feedback 406 based on market interest, classifying the feedback under categories such as “uninterested,” “low,” “medium,” or “high.” The strength of the demand for each feature may be determined by analyzing the frequency and tone of mentions in the feedback 406, enabling the identification of the most sought-after improvements and the market size for each enhancement.

For example, in an embodiment, product enhancements specified in conversational language may be translated to the designs or changes in the product. The desire of the market for the features or the market size can be determined through analysis of conversations wherein a strength or level of desire for the product enhancement is captured. The product features’ needs is grouped into predetermined categories from detection of the interest in the crowd conversation of each thread. Interest can be detected through analysis of sentences, the topic/topics of discussion, and the group of the words are abstracted to determine if the phrases/words can be categorized into other groups of categorical data such as information seeking, expressions of opinion, basis determinants, etc.

Following feedback analysis, a decision on whether new features should be added may be made, in addition/trade-off analysis 408. Feature root traceability may be carried out to map the necessary manufacturing tasks and processes that may be used to integrate the new features into the product. This stage involves prioritizing the features based on importance and feasibility, including human judgment to assess trade-offs between new additions and existing design constraints.

Once the features are identified, alterations in the manufacturing workflow for feature implementation may be mapped by updating machine instructions, design specifications, and potentially altering the manufacturing steps to accommodate new features. For example, if a new feature requires additional components or materials, the system may adapt the manufacturing process to ensure compatibility. Workflow changes are optimized to produce bot instructions 410 that may also reduce (e.g., minimize) disruption to ongoing production, ensuring that new product variants can be seamlessly integrated into the factory’s existing operations.

Prototypes of new product designs may be created based on the identified features and manufacturing process adjustments. The system manages prototype orders 412, tracking their progress and ensuring alignment with production schedules. These prototypes orders 412 are used to build prototypes for beta testing, providing information about how well the new features and manufacturing processes perform in a real-world environment.

In examples, prototypes are manufactured in a process of prototype order manufacturing 414, where advanced manufacturing techniques and automation can allow for rapid iteration and testing. During beta testing, feedback 416 from a targeted group of consumers can be collected to assess the performance and the effectiveness of the new features. Waste module 418 may monitor material discard and reuse, reducing (e.g., minimizing) waste during the manufacturing of prototypes and final products.

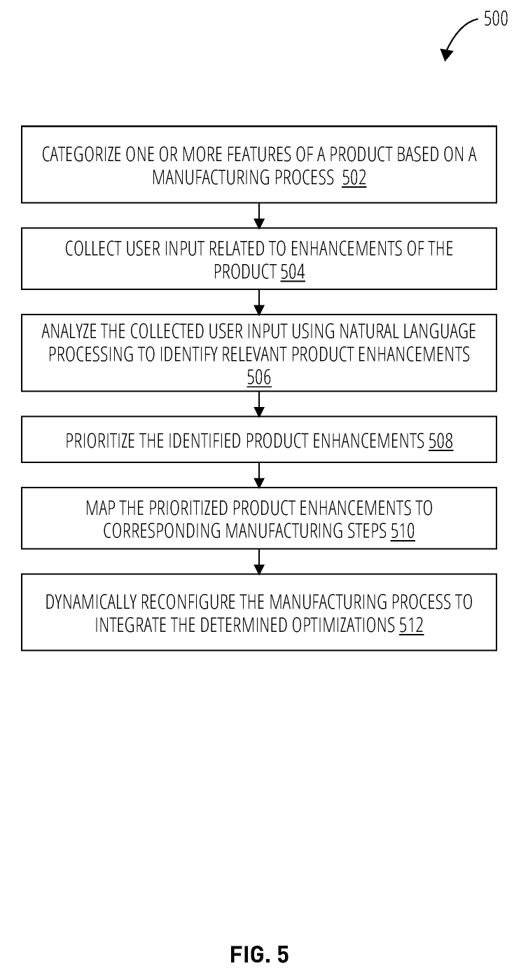

FIG. 5 illustrates a flowchart depicting a routine 500 for manufacturing in a feedback-driven manufacturing environment. The routine may be performed by the manufacturing engine 126. The process begins at block 502 wherein the manufacturing engine 126 categorizes one or more features based on a manufacturing process comprising a plurality of operations.

In block 504, the manufacturing engine 126 collects user input related to enhancements of the product. In an embodiment, the user input related to product enhancements is collected through various sources, including social media platforms, crowdsourcing platforms, and feedback channels. In block 506, the manufacturing engine 126 analyzes the collected user input to identify relevant product enhancements using natural language processing (NLP). An NLP module applies sentiment analysis to classify feedback as, for example, positive, neutral, or negative. In an embodiment, the analysis also incorporates market trends, estimated demand, and/or potential market size to prioritize enhancements effectively. For example, potential market size is determined by studying consumer purchasing trends, seasonal demand fluctuations, or regional preferences. If feedback from tropical regions emphasizes the need for heat-resistant materials, this insight informs decisions about material selection and production focus.

In block 508, the manufacturing engine 126 prioritizes identified product enhancements by performing a trade-off analysis. This analysis considers factors such as resource utilization, production time, and operational constraints. In an embodiment, a natural language model may perform the trade-off analysis. The trade-off analysis may further include evaluating the enhancements based on environmental impact, energy consumption, and compatibility with existing manufacturing infrastructure. Alternatively, a multi-criteria decision-making framework evaluates the enhancements based on environmental impact, energy consumption, and compatibility with existing manufacturing infrastructure. For instance, introducing a fray-resistant seat belt material may involve higher material costs but reduce replacement rates, thereby reducing (e.g., minimizing) long-term environmental impact.

In block 510, the manufacturing engine 126 maps prioritized enhancements to the corresponding manufacturing operations to identify adjustments in the manufacturing process. In an embodiment, this mapping is carried out dynamically, utilizing, for example, a machine-learning algorithm that optimizes the assembly line configuration. In block 512, the manufacturing engine 126 dynamically reconfigures the manufacturing process or manufacturing line to integrate the determined optimizations or to produce new product variants based on the prioritized product enhancements. The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for manufacturing in a manufacturing environment, comprising:
categorizing one or more features of a product based on a manufacturing process comprising a plurality of manufacturing operations, wherein each manufacturing operation is associated with a corresponding feature of the product;
collecting user input related to enhancements of the product;
generating from the collected user input, using natural language processing, a plurality of product enhancements;
prioritizing one or more product enhancements of the plurality of product enhancements by performing a trade-off analysis based on one or more of resource utilization, production time, and operational constraints;
mapping the prioritized one or more product enhancements to respective manufacturing operations to identify adjustments in the manufacturing process for producing one or more prototypes of the product that include the prioritized one or more product enhancements; and
dynamically reconfiguring the manufacturing process to implement the identified adjustments.

2. The method of claim 1, further comprising:
producing and refining the one or more prototypes of the product by at least one of:
generating the one or more prototypes based on the prioritized one or more product enhancements;
testing the one or more prototypes with target users; or
iteratively refining the one or more prototypes based on feedback received during the testing.

3. The method of claim 2, further comprising analyzing the one or more prototypes to obtain performance metric information.

4. The method of claim 1, further comprising filtering user input based on predefined criteria comprising one or more of product relevance, user demographics, and geographic location.

5. The method of claim 1, wherein the trade-off analysis is conducted using natural language processing.

6. The method of claim 1, further comprising generating a simulation model to predict an impact of the prioritized one or more product enhancements on production efficiency before implementing the adjustments.

7. The method of claim 1, wherein the dynamic reconfiguration of the manufacturing process utilizes a machine-learning-based algorithm to adjust assembly line setups for reduced downtime and material wastage.

8. The method of claim 1, wherein the natural language processing comprises:
sentiment analysis of the user input to classify feedback as positive, neutral, or negative; and
keyword extraction to identify specific product features mentioned in the feedback.

9. The method of claim 1, wherein the user input is collected through social media platforms, crowdsourcing, or feedback channels.

10. The method of claim 9, wherein prior to generating the plurality of product enhancements from the user input, the user input is categorized based on a level of interest detected in the user input.

11. The method of claim 9, wherein a potential market size is determined based on user input for use in prioritizing the one or more product enhancements.

12. A computing device comprising:
a processor; and
a memory, in communication with the processor, with one or more computer program instructions stored on the memory, the computer program instructions, when executed by the processor, cause the computing device to perform operations comprising:
categorizing one or more features of a product based on a manufacturing process comprising a plurality of manufacturing operations, wherein each manufacturing operation is associated with a corresponding feature of the product;
collecting user input related to enhancements of the product;
generating from the collected user input a plurality of product enhancements, by using natural language processing;
prioritizing one or more product enhancements of the plurality of product enhancements by performing a trade-off analysis based on one or more of resource utilization, production time, and operational constraints;
mapping the prioritized one or more product enhancements to respective manufacturing operations to identify adjustments in the manufacturing process for producing one or more prototypes of the product that include the prioritized one or more product enhancements; and
dynamically reconfiguring the manufacturing process to implement the identified adjustments.

13. The computing device of claim 12, wherein the execution of the program instructions by the processor further configures the computing device to perform operations comprising:
producing and refining the one or more prototypes of the product by at least one of:
generating the one or more prototypes based on the prioritized one or more product enhancements;
testing the one or more prototypes with target users; or
iteratively refining the one or more prototypes based on feedback received during the testing.

14. The computing device of claim 12, wherein the execution of the program instructions by the processor further configures the computing device to perform operations comprising analyzing the one or more prototypes to obtain performance metric information.

15. The computing device of claim 12, wherein the execution of the program instructions by the processor further configures the computing device to perform operations comprising filtering user input based on predefined criteria comprising one or more of product relevance, user demographics, and geographic location.

16. The computing device of claim 12, wherein the trade-off analysis is conducted using natural language processing.

17. The computing device of claim 12, wherein the execution of the program instructions by the processor further configures the computing device to perform operations comprising generating a simulation model to predict an impact of the prioritized one or more product enhancements on production efficiency before implementing the adjustments.

18. The computing device of claim 12, wherein the dynamic reconfiguration of the manufacturing process utilizes a machine-learning-based algorithm to adjust assembly line setups for reduced downtime and material wastage.

19. A computer program product for manufacturing in a manufacturing environment, the computer program product comprising:
one or more computer-readable storage devices and program instructions stored on the at least one of the one or more computer-readable storage devices, the program instructions executable by a processor, the program instructions comprising:
program instructions to categorize one or more features of a product based on a manufacturing process comprising a plurality of manufacturing operations, wherein each manufacturing operation is associated with a corresponding feature of the product;
program instructions to collect user input related to enhancements of the product;
program instructions to generate from the collected user input, using natural language processing, a plurality of product enhancements;
program instructions to prioritize one or more product enhancements of the plurality of product enhancements by performing a trade-off analysis based on one or more of resource utilization, production time, and operational constraints;
program instructions to map the prioritized one or more product enhancements to respective manufacturing operations to identify adjustments in the manufacturing process for producing one or more prototypes of the product that include the prioritized one or more product enhancements; and
program instructions to dynamically reconfigure the manufacturing process to implement the identified adjustments.

20. The computer program product of claim 19, wherein the program instructions further comprise:
program instructions to produce and refine the one or more prototypes of the product by at least one of:
program instructions to generate the one or more prototypes based on the prioritized one or more product enhancements;
program instructions to test the one or more prototypes with target users; or
program instructions to iteratively refine the one or more prototypes based on feedback received during the testing.
